(19) United States
(12) Patent Application Publication
(10) Pub. No.: US 2025/0024927 A1
(43) Pub. Date: Jan. 23, 2025

(54) APPLIANCE FOR SUPPLYING HEATED AIR

(71) Applicant: Dyson Technology Limited, Malmesbury, Wiltshire (GB)

(72) Inventors: Anais Isabelle LEUNG-PIN, Bristol (GB); Maurizio BALLARATI, Swindon (GB)

(21) Appl. No.: 18/708,439

(22) PCT Filed: Dec. 1, 2021
(86) PCT No.: PCT/GB2021/053130

§ 371 Date: May 8, 2024

(30) Foreign Application Priority Data
Nov. 12, 2021 (GB) 2116328.2

(51) Int. Cl. A45D 20/12; H05B 3/16

(52) U.S. Cl. CPC A45D 20/122; H05B 3/16; H05B 2203/022

(57) ABSTRACT

A hair care appliance is provided and includes a heater having a heating element, an airflow passage extending from an airflow inlet to an airflow outlet, and an air mover for moving airflow along the passage from the inlet to the outlet. The appliance further includes a thermal barrier at least partly surrounding the airflow passage so as to restrict heat transfer from the heater to an external surface of the appliance. The thermal barrier includes an inner wall proximal to the heater, an outer wall distal from the heater, and a sealed evacuated space defined between the inner and outer walls.

### TECHNICAL FIELD

The present disclosure relates to an appliance for supplying heated air. The disclosure finds particular, but not exclusive, use in hair care appliances.

### BACKGROUND

Various appliances are known that supply a flow of heated air. For example, hair care appliances (e.g. hair dryers, curlers and stylers) are known that discharge heated air onto a user's hair for drying and/or styling. Also known are heater fans that discharge heated air into a space for the purpose of increasing the temperature in the space.

Typically, such appliances include a heater that heats an airflow that is subsequently discharged from the appliance. Both the airflow and the heater are usually housed in a housing that includes an outlet for discharge of the air. It is important that an external surface of this housing is maintained at a temperature that does not cause injury or discomfort to a user touching the surface.

In such appliances, however, there can be a desire to maximise the temperature of the air that is discharged by the appliance. For example, in the case of a heated fan, this can allow the fan to increase the temperature of a space more rapidly. In the case of hair care appliances, higher temperatures can provide faster drying and/or better styling ability. Accordingly, there is a desire to increase power and/or heat output.

There is also often a desire to minimise the external dimensions of an appliance. For example, hair care appliances are often handheld and the larger a handheld appliance is, the more difficult it is for a user to handle the appliance.

The combination of a housing of limited size and increased heating power conflicts with the need to maintain the external temperatures of the appliance at a desirable level.

The present disclosure has been devised in light of the above considerations.

### SUMMARY

In a first aspect there is disclosed a hair care appliance for applying heat to a user's hair, the appliance comprising:
an airflow passage extending from an airflow inlet to an airflow outlet;
an air mover for moving airflow along the passage from the inlet to the outlet;
a heater arranged to heat air in the airflow passage, the heater comprising a heating element; and
a thermal barrier at least partly surrounding the heater, the thermal barrier comprising an inner wall proximal to the heater, an outer wall distal from the heater, and a sealed evacuated space defined between the inner and outer walls.

It has been found that thermal barriers that include evacuated spaces can provide a high level of thermal insulation without requiring significant space within the appliance. Hence, such a thermal barrier takes up minimal space about the air passage while maintaining an external surface of the appliance at a desirable temperature. This allows the external dimensions of the appliance to be minimised without detriment to user safety or comfort. Likewise, by reducing the space in the appliance required for insulation, a larger heater may be provided, which has benefits for heater reliability, heat transfer to air passing across the heater, and integration of the heater with the appliance.

For the avoidance of doubt, the term “evacuated” as used herein means that the space is at a lower pressure than the pressure external to the appliance (e.g. atmospheric pressure). For example, the space may be under vacuum.

The heater may optionally extend across (e.g. substantially entirely across) the airflow passage such that air in the airflow passage flows across the heating element in use. The heating element may extend in a direction across the airflow passage. The heating element may extend substantially entirely across the airflow passage.

In a second aspect, there is disclosed an appliance comprising:
an airflow passage extending from an airflow inlet to an airflow outlet;
an air mover for moving airflow along the passage from the inlet to the outlet;
a heater extending across the airflow passage, the heater comprising a heating element across which air in the passage flows in use; and
a thermal barrier at least partly surrounding the heater, the thermal barrier comprising an inner wall proximal the heater, an outer wall distal from the heater, and a sealed evacuated space defined between the inner and outer walls.

As already discussed above, the provision of a thermal barrier with an evacuated space allows an external surface of the appliance to be maintained at a desirable temperature while minimising the external dimensions of the appliance. This may be especially important where the heater extends across the airflow passage, because such an arrangement brings the extremities of the heater closer to an external wall of the appliance.

Optional features of the first and second aspects will now be set out. These are applicable singly or in any combination with any aspect. For the avoidance of doubt, references to an “appliance” below are references to the appliance of the second aspect and/or the hair care appliance of the first aspect.

The thermal barrier may extend fully about (i.e. may encircle) the heater. The thermal barrier may be tubular. The airflow passage may extend through the tubular thermal barrier (i.e. through the central cavity of the tube). For the avoidance of doubt, the term “tubular” is not intended to restrict the thermal barrier to a circular cross-sectional shape (it could otherwise be, e.g. obround, octagonal, hexagonal, elliptical, square, rectangular, etc. in cross-section).

The thermal barrier may comprise a bend along its length such that opposing openings of the thermal barrier are angled with respect to one another (e.g. at an angle between 45° and 70°, or between 50° and 65°, or about 55°). The heater may be disposed in the bend of the thermal barrier. The thermal barrier may extend along a curved path. In this way, the passage may be curved (i.e. may extend along a curved path). Alternatively, the thermal barrier may be formed of two linearly extending portions angled with respect to one another.

A cross-sectional shape of the airflow passage may be complementary to a shape of the outer periphery of the heater so that the heater fits closely within the airflow passage. Thus, there may be no space (or limited space) between the periphery of the heater and a wall defining the airflow passage (e.g. the inner wall of the thermal barrier). The heater may, for example, fill more than 80% of the cross-sectional area of the airflow passage, or more than 90% of the cross-sectional area or more than 95% of the cross-sectional area. The heater may fill 100% of the cross-sectional area of the airflow passage. This may ensure that substantially all airflow in the airflow passage passes through/across the heater, which may help to maximise the efficiency of the airflow heater.

Likewise, the heating element of the heater may extend substantially entirely across the airflow passage. For example, the length of the heating element may be more than 80%, or more than 85%, or more than 90% of the distance between two opposing wall regions of the air passage between which it extends.

The heater may be mounted directly to the inner wall of the thermal barrier. This may help to minimise the external dimensions of the appliance (i.e. by removing any need for a separate mounting arrangement that may take up space).

The heating element of the heater may be in direct contact with the inner wall of the thermal barrier. Again, this may help to minimise the external dimensions of the appliance. It may maximise the cross-sectional area of the airflow exposed to the heating element.

The inner wall of the thermal barrier may comprise a mounting portion for mounting the heater in the airflow passage. The mounting portion may be in the form of a recess or protrusion (i.e. extending into the airflow passage) formed in or on the inner wall. The heater may comprise a corresponding feature configured to interact (e.g. engage) with the mounting portion. In other embodiments, the mounting portion may comprise e.g. a clip, mounting bar, etc. affixed to the internal wall.

The mounting portion may be configured for snap engagement with a heater in the airflow passage. The mounting portion may comprise a ramp surface configured to guide the heater into (or out of) engagement therewith. For example, when the mounting portion is in the form of a protrusion, the mounting portion may have a wedge shape. The leading/trailing edges of the ramp surface may be transverse to a direction of extension of the passage (e.g. transverse to an airflow direction of the passage).

The mounting portion, when present, may be referred to as an internal mounting portion, and the thermal barrier may further comprise an external mounting portion for mounting the thermal barrier within a housing of the appliance. The external mounting portion may be directly opposite the internal mounting portion across the sealed space. The housing of the appliance may comprise a feature configured to interact (e.g. engage) with the external mounting portion. When the internal mounting portion is a recess, the external mounting portion may be a protrusion. When the internal mounting portion is a protrusion, the external mounting portion may be a recess. The external mounting portion may have the same shape as the internal mounting portion.

The internal mounting portion may extend in a direction along the passage (e.g. in an airflow direction of the passage). The internal mounting portion may extend circumferentially about the inner wall. The inner wall may comprise a plurality of mounting portions (i.e. each in the form of a recess or protrusion).

A cross-sectional shape of the outer wall of the thermal barrier may have a linear portion (i.e. such that a portion of the external surface of the thermal barrier is planar). A cross-sectional shape of the outer wall of the thermal barrier may be obround or octagonal. The term “obround” is used herein to describe a generally rectangular shape with arcuate (rather than linear) ends—that is, two opposite parallel edges connected by two curved edges (so as to form a ‘racetrack’ or ‘stadium’ shape). The provision of a thermal barrier having a planar external surface (such as in the case of an obround or octagonal shape) may define a space between an external surface of the thermal barrier and a housing of the appliance extending about the thermal barrier (e.g. when the housing has a substantially circular/elliptical cross-sectional shape and circumscribes the thermal barrier). This space may be utilised for e.g. electronic componentry of the appliance.

The cross-sectional shape of the outer boundary of the thermal barrier may be uniform along the length (i.e. substantially the entire length) of the thermal barrier. The cross-sectional shape of the thermal barrier may be uniform along the length (i.e. substantially the entire length) of the thermal barrier. For example, the cross-sectional shape of the thermal barrier (or only the outer boundary) may be uniform along substantially the entire length of the thermal barrier except for the presence of external/internal mounting portions.

The inner and outer walls may be concentrically arranged. In this respect, the evacuated space may have an annular cross-sectional shape.

The outer wall of the thermal barrier may define an external wall of the appliance. This may allow the external dimensions of the appliance to be reduced (by removing the need for a housing surrounding the thermal barrier).

In other embodiments (as mentioned above) the appliance may comprise a housing that substantially (e.g. entirely) surrounds the thermal barrier. The housing may circumscribe the thermal barrier. The housing may define an external wall of the appliance. The housing may be formed of an electrically insulating material. The housing may be formed of e.g. plastic (e.g. may comprise nylon, such as glass-fibre reinforced nylon). As set forth above, the housing may comprise a circular or elliptical cross-sectional shape (but may take other shapes).

The outer wall (of the thermal barrier) may be thicker than the inner wall. In use, the outer wall of the thermal barrier may be susceptible to higher forces than the inner wall (such as from impact due to the appliance being dropped from a height). Maintaining the inner wall at a smaller thickness than the outer wall helps to minimise the space that the thermal barrier takes up within the appliance.

One or both of the outer and inner walls may have a thickness between 0.2 mm and 0.8 mm, or between 0.3 mm and 0.5 mm, or about 0.3 mm. The distance between the walls (i.e. the width of the evacuated space) may be between 0.3 mm and 0.8 mm, or between 0.4 and 0.6 mm, or about 0.5 mm.

The thermal barrier may comprise a metal, e.g. may comprise steel (e.g. stainless steel). In this way, the thermal barrier may form a structural component of the appliance. By providing this dual functionality (insulation and structure), the thermal barrier may reduce the complexity of the appliance and may also help to reduce the external dimensions of the appliance. The inner and outer walls of the thermal barrier may be connected to one another, for example at opposing ends of the thermal barrier (i.e. at a downstream end and an upstream end of the thermal barrier-the terms “upstream” and “downstream” being used in reference to the direction of airflow along the airflow passage).

A downstream end of the thermal barrier may be disposed proximate to (or at) the outlet of the airflow passage. The downstream and upstream ends of the thermal barrier may be susceptible to the formation of hot spots. However, the outlet of an appliance supplying heated air is typically a region in which the housing of an appliance experiences high temperature due to the presence of the discharged heated air, and as such it is a region of an appliance that a user will not usually be inclined to handle. Accordingly, positioning the downstream end of the thermal barrier proximate to or at the outlet of the airflow passage means that a user is less likely to come into contact with hot spots formed at the downstream end.

The thermal barrier may further comprise a single-walled section (e.g. which may comprise only one of the outer and inner walls). The single-walled section may be an extension of the thermal barrier, i.e. an extension of the double-walled section of the thermal barrier. In this respect, the thermal barrier may comprise a double-walled section (as described above), referred to herein as a primary section, and a single-walled section, referred to herein as a secondary section. The primary and secondary sections may be integral with one another. For example, one of the inner and outer walls may extend beyond an end of the other of the inner and outer walls (to form the secondary section). That is, the secondary section may be an extension of one of the inner and outer walls from the primary section.

The secondary section may house one or more components other than the heater (e.g. may comprise mounting portions as described above for mounting such components therein). For example, the secondary section may house one or more of an air mover (e.g. motor with impeller), PCB or a sensor. In this way, the heater and other components of the appliance may be mounted within a single structure. This may improve the mechanical robustness of the appliance (e.g. by preventing relative movement between the mounted components).

The secondary section may substantially surround the airflow passage.

The primary section may extend for the entire length of the heater. The primary section may extend for greater than the length of the heater. For example, the primary section may extend beyond the heater on one or both sides of the heater.

The secondary section may be longer than the primary section. The secondary section may extend from the primary section to the airflow inlet. The secondary section may extend from the primary section to an end of the appliance. The secondary section may extend for a substantial length (e.g. the entire length) of a handle of the appliance.

The primary section may have a length of between 80 mm and 100 mm, or about 90 mm, and the secondary section may have a length of between 20 and 40 mm, or about 30 mm.

The thermal barrier may extend for a substantial length (e.g. the entire length) of a handle of the appliance. In some embodiments, the thermal barrier may extend for a substantial length (e.g. the entire length) of the appliance (e.g. of a body of the appliance.

The appliance may be configured such that the thermal barrier is electrically isolated from the heater (and e.g. other electronic components of the appliance). This may be especially desirable when the thermal barrier is exposed to a user of the appliance (e.g. when the thermal barrier defines an external surface of the device). For example, an inner surface of the inner wall of the thermal barrier may comprise an electrically insulative coating.

Alternatively or additionally, the thermal barrier may be electrically connected to an earthing wire configured for electrical connection to ground in use. The earthing wire may be provided as part of an electrical connector of the appliance for connecting the appliance to a mains power supply.

The heater may be a ceramic heater. Such heaters may allow a high heat output within a small spatial envelope. The heater may be configured to operate at a temperature of more than 250° C., or e.g. more than 280° C., or e.g. about 300° C. during operation of the appliance.

The air mover may be in the form of a fan or a pump.

The appliance may be configured such that an external surface of the appliance adjacent the thermal barrier is maintained below 50° C. in normal use, or e.g. below 48° C., or below 45° C., or below 43° C.

The appliance may be one of a heated fan, hair dryer, hair styler (that makes use of heated air to style hair), a hair curler (with heated air flow), and a heated hair brush (with heated air flow).

The appliance may be a handheld device. The heater may be disposed within a handle of the handheld device (i.e. in a portion of the device arranged to be held by a user in normal use).

In a third aspect, there is provided a thermal barrier for an appliance, the thermal barrier comprising:
concentrically arranged inner and outer tubular walls, a passage defined by the inner wall and extending through the thermal barrier between opposing openings thereof;
a sealed evacuated space defined between the inner and outer walls; and
a mounting portion for mounting a heater across the passage, the mounting portion in the form of a recess or protrusion formed in the inner wall.

As already set forth above, the provision of a thermal barrier (configured or use with a heater extending thereacross) can minimise temperatures at an external surface of the appliance while allowing the external dimensions of the appliance to also be minimised.

Optional features of the third aspect will now be set out. These are applicable singly or in any combination with any aspect. For the avoidance of doubt, references to an

The thermal barrier may comprise a bend along its length such that the opposing openings of the thermal barrier are angled with respect to one another. The mounting portion may be disposed in the bend of the thermal barrier. The thermal barrier may extend along a curved path. In this way, the passage may extend along a curved path. Alternatively, the thermal barrier may be formed of two linearly extending portions angled with respect to one another.

A cross-sectional shape of the outer wall of the thermal barrier may have a linear portion (i.e. such that a portion of the external surface of the thermal barrier is planar). A cross-sectional shape of the outer wall of the thermal barrier may be obround or octagonal.

The mounting portion may be configured for snap engagement with a heater in the airflow passage. The mounting portion may comprise a ramp surface configured to guide the heater into (or out of) engagement therewith. For example, when the mounting portion is in the form of a protrusion, the mounting portion may have a wedge shape. The leading/trailing edges of the ramp surface may be transverse to a direction of extension of the passage.

The mounting portion may be referred to as an internal mounting portion and the thermal barrier may further comprise an external mounting portion. The external mounting portion may be directly opposite the internal mounting portion across the sealed space. The external mounting portion may be configured for mounting the thermal barrier with a housing of an appliance.

When the internal mounting portion is a recess, the external mounting portion may be a protrusion. When the internal mounting portion is a protrusion, the external mounting portion may be a recess. The external mounting portion may have the same shape as the internal mounting portion.

The internal mounting portion may extend in a direction along the passage. The internal mounting portion may extend circumferentially about the inner wall. The inner wall may comprise a plurality of mounting portions (i.e. each in the form of a recess or protrusion).

The thermal barrier may further comprise a single-walled section (e.g. which may comprise only one of the outer and inner walls). The single-walled section may be an extension of the thermal barrier, i.e. an extension of the double-walled section of the thermal barrier. In this respect, the thermal barrier may comprise a double-walled section (as described above), referred to herein as a primary section, and a single-walled section, referred to herein as a secondary section.

The primary and secondary sections may be integral with one another. For example, one of the inner and outer walls may extend beyond an end of the other of the inner and outer walls (to form the secondary section). That is, the secondary section may be an extension of one of the inner and outer walls from the primary section.

The secondary section may be configured for mounting components other than a heater therein (e.g. may comprise mounting portions as described above for mounting components therein). For example, the secondary section may be configured for mounting one or more of an air mover (e.g. motor with impeller), PCB or a sensor therein. In this way, the heater and other components of an appliance (in which the thermal barrier is installed) may be mounted within a single structure.

The primary section may have a length of between 80 mm and 100 mm, or about 90 mm, and the secondary section may have a length of between 20 and 40 mm, or about 30 mm.

The thermal barrier may be as otherwise described with respect to the first and second aspects (including optional features of those aspects).

### BRIEF SUMMARY OF THE FIGURES

Embodiments will now be discussed with reference to the accompanying figures in which:

FIG. 1A is a transverse cross-sectional view of a portion of a first embodiment of an appliance;

FIG. 1B is a longitudinal cross-sectional view of a portion of the first embodiment of the appliance;

FIG. 2 is a perspective view of a thermal barrier according to a second embodiment;

FIG. 3A is a section view of a hair care appliance according to a third embodiment;

FIG. 3B is a detailed section view of the hair care appliance of the third embodiment; and

FIG. 3C is a perspective view of a thermal barrier of the third embodiment.

### DETAILED DESCRIPTION

Aspects and embodiments will now be discussed with reference to the accompanying figures. Further aspects and embodiments will be apparent to those skilled in the art.

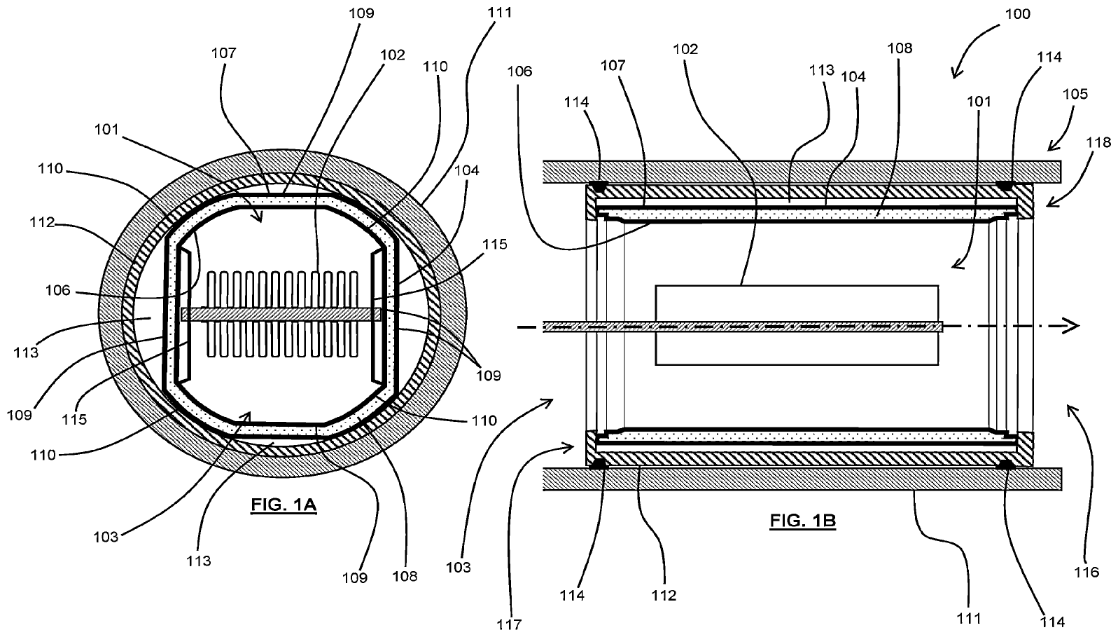

FIGS. 1A and 1B illustrate a portion of an appliance 100 that includes a heater 101 having a heating element 102. The heater 101 is a ceramic heater and is disposed within an airflow passage 103 that extends from an airflow inlet (not shown) to an airflow outlet 116 of the appliance such that air in the airflow passage 103 flows across the heating element 102 in use.

The appliance 100 further comprises an air mover (not shown) for moving the airflow along the passage 103 and across the heating element 102. A tubular thermal barrier 104 surrounds (so as to define a portion of) the airflow passage 103. In this way, the thermal barrier 104 restricts heat transfer from the heater 101 to an external surface of the appliance 100, which is defined by a tubular housing 105 in which the heater 101, airflow passage 103 and thermal barrier 104 are housed.

The thermal barrier 104 comprises a tubular inner wall 106 proximal to the heater 101 and a tubular outer wall 107 distal from the heater 101. The inner 106 and outer 107 walls are concentrically arranged, and upstream 117 and downstream 118 ends of the walls 106, 107 are connected (brazed) to one another so that they define a substantially hermetically-sealed evacuated space 108 (i.e. under vacuum) therebetween. The thermal barrier 104 is longer than the heating element 102 so that a portion of the thermal barrier 104 extends beyond each of the upstream 117 and downstream 118 ends of the heating element 102.

As already discussed above, the provision of a thermal barrier 104 that includes a sealed evacuated space 108 results in a high level of thermal insulation over a minimal distance (i.e. so as to allow the external cross-sectional dimensions of the appliance 100 to be minimised). In the illustrated embodiment, the inner 106 and outer 107 walls each have a thickness of 0.3 mm and the distance between them (defining the evacuated space 108) is 0.5 mm.

Both of the inner 106 and outer 107 walls of the thermal barrier 104 have a generally octagonal cross-sectional shape (taken transverse to the extension of the passage 103 as shown in FIG. 1A). In particular, the octagonal shape includes four linear sides connected by four arcuate corners. Each of the inner 106 and outer 107 walls have a substantially uniform cross-section for substantially the entire length of the thermal barrier 104 (except for at upstream 117 and downstream 118 ends of the thermal barrier 104). This means that the four linear sides of the cross-sectional shape of each wall 106, 107 define corresponding planar surfaces 109 that are connected by arcuate corner surfaces 110 (for clarity, only some of these surfaces are labelled in FIG. 1A).

As set forth above, the thermal barrier 104 is mounted in a housing 105. The housing 105 includes an outer sleeve 111 and an inner core 112 mounted within the outer sleeve 111 (via rubber mounting members 114 that provide shock absorption). Both the outer sleeve 111 and inner core 112 are tubular and have circular cross-sectional shapes, which means that when the thermal barrier 104 is mounted in the inner core 112, spaces 113 are formed between the planar surfaces 109 of the thermal barrier 103 and an inner surface of the inner core 112. Although not illustrated, these spaces 113 may be used to house electronic (or other) components of the appliance 100.

As is apparent from FIG. 1A in particular, the heater 101 and the heating element 102 extend transversely across the airflow passage 103. To facilitate this, the thermal barrier 104 is provided with mounting portions 115 in the form of steel retainers that project inwardly from the inner wall 106 into the airflow passage 103. The mounting portions 115 engage the heater 101 so as to retain the heater 101 in its position extending across the airflow passage 103. In other embodiments, the heater 101 may be directly mounted to the inner wall 106 of the thermal barrier 104.

The thermal barrier 104 is formed of stainless steel. The inner core 112 and outer sleeve 111 of the housing are both formed of plastic (nylon reinforced with glass fibre). This prevents any risk of an electrical current passing from the heater 101 to an external surface of the appliance 100 via the (conductive) thermal barrier 104.

In use, air is driven through the airflow passage 103 by the air mover (not shown) and is heated by the heater 101 before being discharged from the outlet 116. Heat from the heater 101 is restricted from passing from the heater 101 to the external walls of the housing 105 by way of the thermal barrier 104. As may be appreciated, however, some heat may conduct to the upstream 117 and downstream 118 ends of the thermal barrier 104, where the ends of the walls 106, 107 are connected to one another. The downstream end 118 of the thermal barrier 104 is disposed proximate to the outlet 116. As already described above, this is a region of the appliance 100 that a user is unlikely to come into contact with, and therefore this positioning of the thermal barrier 104 reduces the possibility of a hotspot causing injury or discomfort to a user.

It should be appreciated that the appliance 100 of FIGS. 1A and 1B could be any one of a heated fan, hair dryer, hair styler (that makes use of heated air to style hair), a hair curler (with heated air flow), and a heated hair brush (with heated air flow).

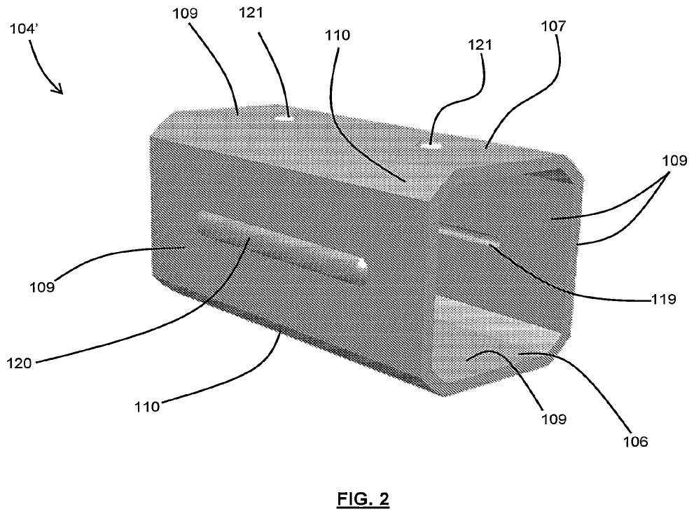

FIG. 2 illustrates an embodiment of a thermal barrier 104′ that may, for example, be used in the appliance 100 described above. This thermal barrier 104′ is similar to that described above with reference to FIGS. 1A and 1B, and for that reason the same reference numerals have been used to denote the same features.

Like the previously described embodiment, the thermal barrier 104′ of FIG. 2 is a tubular steel structure that includes concentric inner 106 and outer 107 walls that define an internal evacuated space (not shown). Both of the walls 106, 107 have a generally octagonal cross-sectional shape, each with four planar surfaces 109 connected by four corresponding arcuate corner portions 110 (the corner portions 110 having a greater radius than those shown in FIG. 1A).

This embodiment of the thermal barrier 104′ differs from that previously described in that it is configured for direct mounting of a heater to the inner wall 106 of the thermal barrier 104′. This is achieved by way of two internal mounting portions (only one of which is visible in FIG. 2) in the form of longitudinally extending elongate recesses 119 formed in opposing planar side surfaces 109 of the inner wall 106. Each of these recesses 119 has a rounded profile which facilitates insertion and removal of a heater in the thermal barrier 104′.

The thermal barrier 104′ additionally includes two pairs of external mounting portions. Each of these external mounting portions is for mounting the thermal barrier 104′ within the housing of an appliance. A first pair of external mounting portions are in the form of elongate protrusions 120 (only one is visible in FIG. 2) that extend longitudinally along opposite side surfaces 109 of the outer wall 107. Each of these elongate protrusions 120 are positioned directly opposite (across the evacuated space) a corresponding elongate recess 119 and has the same shape as the recess 119. In this way, a substantially uniform gap is provided between the inner 106 and outer walls 107 (i.e. providing the evacuated space with a substantially uniform width along the length of the thermal barrier 104′). A second pair of external mounting portions is provided on an upper surface of the thermal barrier 104′ and these are in the form of hemispherical protrusions 121. Although not shown, two corresponding hemispherical recesses are formed in the upper surface of the inner wall 106 so as to be positioned directly opposite the hemispherical protrusions 121. Again, this ensures that a constant gap is maintained between the inner 106 and outer 107 walls (even in the presence of mounting portions).

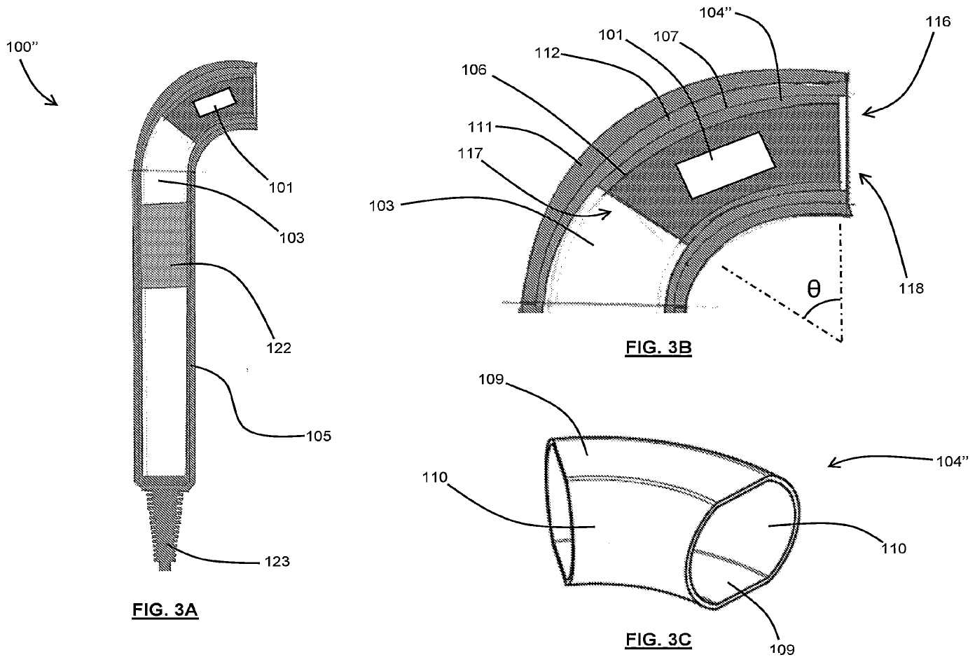

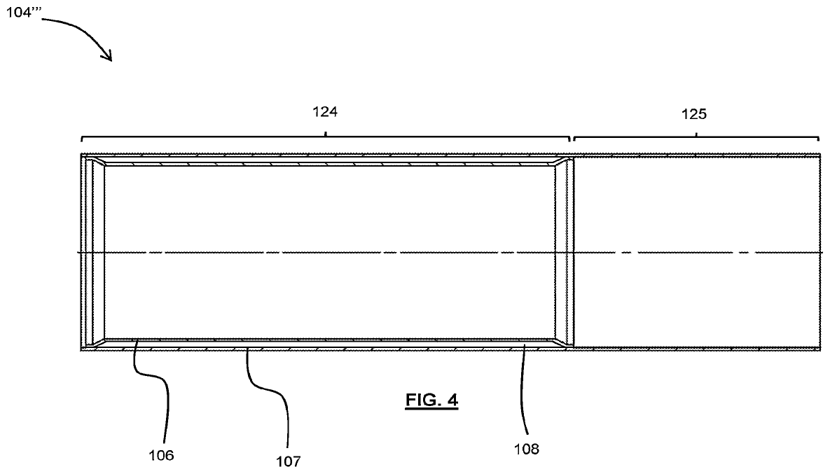

FIGS. 3A to 3C illustrate a third embodiment in the form of a hair care appliance 100″. Many of the features of this hair care appliance 100″ are similar to those of the embodiments described above and therefore the same reference numerals are used. Detailed description of those features that are the same or similar will not be repeated.

The hair care appliance 100″ includes a heater 101 positioned within an air passage 103 that is surrounded by a thermal barrier 104″. The thermal barrier 104″ is mounted within a tubular housing 105 that comprises an inner core 112 and an outer sleeve 111. Also mounted within the housing 105, in a portion of the passage 103 upstream of the heater 101, is an air mover 122 that moves air through the passage 103 from an inlet (not shown) to an outlet 116 at an end of the housing 105.

Unlike the previously described embodiments, the heater 101 (and thus the thermal barrier 104″) is provided in a curved section of the housing 105 (which defines a curved section of the passage 103). Accordingly, the thermal barrier 104″ is curved along its length, such that openings at the upstream 117 and downstream 118 ends of the thermal barrier 104″ are angled with respect one another (in this case, the angle θ (see FIG. 3B) is approximately 55°).

The thermal barrier 104″ further differs from those previously described in that it has an obround (or ‘racetrack-shaped’) cross-sectional shape. Thus, the thermal barrier includes upper and lower planar surfaces 109 connected by arcuate surfaces 110. Although not apparent from the figures, the provision of planar surfaces 109 means that spaces are formed between the thermal barrier 104″ and the housing 105 for receipt of e.g. electronic components of the appliance 100″.

Once again, the downstream end 118 of the thermal barrier 104″ is positioned so as to be adjacent the outlet 116 of the appliance 100″, which reduces the possibility of a hot spot at that end (arising from interconnection of the inner and outer walls) causing injury or discomfort to a user.

The air mover 122 and the heater 101 are both powered by way of an electrical connection to a mains power supply, via an external cord 123 extending from the appliance 100″. This cord may house an earthing wire that electrically connects to the thermal barrier 104″.

FIG. 4 depicts yet a further embodiment of a thermal barrier 104″. In this case, the thermal barrier 104″' has a circular cross-sectional shape. This can reduce the complexity of manufacturing the thermal barrier 104″ and can also improve the ability of the thermal barrier 104″ to withstand e.g. crushing forces or impact.

The thermal barrier 104″ further differs from those previously described in that it is formed with primary 124 and secondary 125 sections. The primary section 124 has a length of approximately 90 mm and the secondary section 125 has a length of approximately 30 mm.

In the primary section 124, the thermal barrier 104″ includes spaced apart inner 106 and outer 107 walls that define an evacuated space 108 therebetween (i.e. in the same manner as the previously described thermal barriers). The secondary section 125 is formed of an extension of the outer wall 107 beyond the end of the inner wall 106. Thus, the secondary section 125 is a single-wall structure and is integrally formed with the primary section 124.

The primary section 124, as described above, can be configured for receipt of a heater (e.g. by way of the inclusion of internal mounting portions, such as recesses or protrusions) in a similar manner to that shown in FIGS. 1A and 1B. The secondary section 125 can be configured for receipt of other components of an appliance (e.g. can include internal mounting portions such as recesses or protrusions). For example, the secondary section 125 can be configured to contain e.g. an air mover (such as a motor), a sensor and/or a PCB.

The benefit of such an arrangement is that the heater can be mounted along with other components in a single structure. This can increase the mechanical robustness of the assembly. For example, it can reduce movement between the various components of the appliance. This can improve the ability of the appliance to withstand e.g. impact.

The exemplary embodiments set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A hair care appliance for applying heat to a user's hair, the appliance comprising:
an airflow passage extending from an airflow inlet to an airflow outlet;
an air mover for moving airflow along the airflow passage from the airflow inlet to the airflow outlet;
a heater arranged to heat air in the airflow passage, the heater comprising a heating element; and
a thermal barrier at least partly surrounding the heater, the thermal barrier comprising an inner wall proximal to the heater, an outer wall distal from the heater, and a sealed evacuated space defined between the inner and outer walls.

2. The hair care appliance according to claim 1, wherein the heater extends across the airflow passage such that air in the airflow passage flows across the heating element in use.

3. The hair care appliance according to claim 2, wherein a cross-sectional shape of the airflow passage is complementary to a shape of an outer periphery of the heater so that the heater fits closely within the airflow passage.

4. An appliance comprising:
an airflow passage extending from an airflow inlet to an airflow outlet;
an air mover for moving airflow along the airflow passage from the airflow inlet to the airflow outlet;
a heater extending across the airflow passage, the heater comprising a heating element across which air in the airflow passage flows; and
a thermal barrier at least partly surrounding the heater, the thermal barrier comprising an inner wall proximal the heater, an outer wall distal from the heater, and a sealed evacuated space defined between the inner and outer walls.

5. The appliance according to claim 4, wherein a cross-sectional shape of the airflow passage is complementary to the shape of an outer periphery of the heater so that the heater fits closely within the airflow passage.

6. The appliance according to claim 4, wherein the thermal barrier is tubular, the airflow passage extending therethrough.

7. The appliance according to claim 6, wherein the thermal barrier comprises a bend along its length such that opposing openings of the thermal barrier are angled with respect to one another, and wherein the thermal barrier extends along a curved path.

8. (canceled)

9. The appliance according to claim 4, wherein the heater is mounted directly to the inner wall of the thermal barrier.

10. The appliance according to claim 9, wherein the heating element of the heater is in direct contact with the inner wall of the thermal barrier.

11. The appliance according to claim 9, wherein the inner wall comprises a mounting portion for mounting the heater in the airflow passage, the mounting portion in the form of a recess or protrusion formed in the inner wall.

12. The appliance according to claim 11, wherein the mounting portion is an internal mounting portion and the thermal barrier further comprises an external mounting portion directly opposite the internal mounting portion across the sealed evacuated space, the external mounting portion mounting the thermal barrier within a housing of the appliance.

13. The appliance according to claim 12, wherein:
when the internal mounting portion is a recess, the external mounting portion is a protrusion; and
when the internal mounting portion is a protrusion, the external mounting portion is a recess.

14. (canceled)

15. (canceled)

16. The appliance according to claim 4, wherein the inner and outer walls are concentrically arranged.

17. The appliance according to claim 4, wherein the outer wall of the thermal barrier defines an external wall of the appliance.

18. The appliance according to claim 4, wherein the outer wall is thicker than the inner wall.

19. The appliance according to claim 4, wherein an inner surface of the inner wall comprises an electrically insulative coating.

20. (canceled)

21. (canceled)

22. A thermal barrier for an appliance, the thermal barrier comprising:
concentrically arranged inner and outer tubular walls;
a passage defined by the inner tubular wall and extending through the thermal barrier between opposing openings thereof;
a sealed evacuated space defined between the inner and outer tubular walls; and
a mounting portion for mounting a heater across the passage, the mounting portion in the form of a recess or protrusion formed in the inner tubular wall.

23. The thermal barrier according to claim 22, further comprising a bend along a length of the thermal barrier such that the opposing openings of the thermal barrier are angled with respect to one another, wherein the passage extends along a curved path.

24-26. (canceled)

27. The thermal barrier according to claim 22, wherein the mounting portion is an internal mounting portion and the thermal barrier further comprises an external mounting portion directly opposite the internal mounting portion across the sealed evacuated space.

28. The thermal barrier according to claim 27, wherein:
when the internal mounting portion is a recess, the external mounting portion is a protrusion; and
when the internal mounting portion is a protrusion, the external mounting portion is a recess.
